(19) United States
(12) Patent Application Publication
(10) Pub. No.: US 2023/0060056 A1
(43) Pub. Date: Feb. 23, 2023

(54) SYSTEM FOR THERMAL MANAGEMENT OF A GENERATOR

(71) Applicant: PLUG POWER INC., Latham, NY (US)

(72) Inventor: Larry WANG, Latham, NY (US)

(73) Assignee: PLUG POWER INC., Latham, NY (US)

(21) Appl. No.: 17/821,561

(22) Filed: Aug. 23, 2022

Related U.S. Application Data
(60) Provisional application No. 63/235,948, filed on Aug. 23, 2021.

(51) Int. Cl. B60K 11/08; F01P 5/06

(52) U.S. Cl. CPC B60K 11/085; F01P 5/06; F01P 2005/025

(57) ABSTRACT

An electrical generation system for a vehicle includes a vehicle having a generator for producing electric current. The vehicle has a cavity having a fan and a radiator. The radiator is in fluid communication with the generator to allow a temperature of the generator to be controlled. An air inlet passage extends through a wall of the vehicle and is configured to direct air from outside the vehicle toward an inlet side of the radiator to provide increased static pressure of the air to the inlet side of the radiator compared to an ambient pressure of the air when the vehicle is in motion.

### CROSS REFERENCE TO RELATED APPLICATIONS

The present application claims priority to U.S. Provisional Application No. 63/235,948 filed on Aug. 23, 2021, which is incorporated herein by referenced in its entirety.

### TECHNICAL FIELD

The present invention relates, generally, to methods and systems for thermally managing sources of electrical current, and more particularly, to systems and methods for controlling a temperature of fuel cell and battery systems for powering a vehicle.

### BACKGROUND OF THE INVENTION

For a variety of reasons, including the mitigation of climate change, there has been an increase in the production of electrical vehicles including those powered by batteries and electrochemical fuel cells. Such electrical vehicles operate differently from and have thermal requirements different from traditional fossil fuel powered vehicles.

Traditional vehicles include an internal combustion engine located in a front of such a vehicle where the passenger compartment is located to a rear relative to the engine. A radiator may be located at a frontmost end of a vehicle such that air may pass through the radiator to cool liquid in fluid and thermal connection with the engine such that the engine may be cooled by such liquid flowing through the radiator and the engine.

Electric vehicles do not require that an engine be located in any particular location and the front of a vehicle may include a second storage compartment or frunk. Electric motors may be located in or near the wheels of a vehicle and batteries may be located at various locations in the vehicle including the chassis or frame of the vehicle.

Fuel cell electric vehicles may have fuel cells for generating electrical energy located at various portions of a vehicle including the traditional front portion, rear portion or roof of the vehicle. Hydrogen fuel storage containers may also be located at any of these indicated locations.

Fuel cells of Fuel cell electric vehicles may generate heat during operation, and it may be necessary to control a temperature of such fuel cells to promote efficient operation. The control of the temperature of a fuel cell in a vehicle may be done via flow of ambient air over the fuel cell while the vehicle is in motion and/or via a liquid in fluid communication with an interior or exterior of the fuel cell and a radiator.

Thus, a need exists for systems and methods for thermally managing sources of electrical current.

### SUMMARY OF THE INVENTION

The present invention provides in a first aspect, an electrical generation system for a vehicle which includes a vehicle having a generator for producing electric current. The vehicle has a cavity having a fan and a radiator. The radiator is in fluid communication with the generator to allow a temperature of the generator to be controlled. An air inlet passage extends through a wall of the vehicle and is configured to direct air from outside the vehicle toward an inlet side of the radiator to provide increased static pressure of the air to the inlet side of the radiator compared to an ambient pressure of the air when the vehicle is in motion.

The present invention provides in a second aspect, a method for controlling a temperature of an electrical generator including connecting an electrical generator in a vehicle to a radiator in the vehicle via a conduit to provide fluid communication between the electrical generator and the radiator to allow the radiator to cool the electrical generator via a flow of fluid between the electrical generator and the radiator. Air flows from an outside of the vehicle to an inlet side of the radiator through an air inlet passage of the vehicle to provide an increased static pressure of the air to the inlet side of the radiator compared to an ambient pressure of the air when the vehicle is in motion

The present invention provides in a third aspect, a system for controlling a temperature of an electrical generator which includes a radiator in a vehicle coupled to an electrical generator in the vehicle via a conduit to provide fluid communication between the electrical generator and the radiator to allow the radiator to cool the electrical generator via a flow of fluid between the electrical generator and the radiator. An air inlet passage of the vehicle is configured to direct air from an outside of the vehicle to an inlet side of the radiator to provide an increase static pressure of the air to the inlet side of the radiator compared to an ambient pressure of the air when the vehicle is in motion.

### BRIEF DESCRIPTION OF THE DRAWINGS

The subject matter which is regarded as the invention is particularly pointed out and distinctly claimed in the claims at the conclusion of the specification. The foregoing and other features and advantages of the invention will be readily understood from the following detailed description of the preferred embodiments taken in conjunction with the accompanying drawings in which:

FIG. 1 is a perspective view of a top side of a vehicle having an electrical generator and a system for controlling a temperature of the generator;

FIG. 2 is a top view of the top side of the vehicle of FIG. 1;

FIG. 3 is a top cross-sectional view of the top side of the vehicle of FIG. 1 showing louvers extending therethrough; and

FIG. 4 is a perspective view of a radiator-fan assembly of the system for controlling the temperature of the generator of FIG. 1.

### DETAILED DESCRIPTION OF THE INVENTION

The present invention will be discussed hereinafter in detail in terms of various exemplary embodiments according to the present invention with reference to the accompanying drawings. In the following detailed description, numerous specific details are set forth in order to provide a thorough understanding of the present invention. It will be obvious, however, to those skilled in the art that the present invention may be practiced without these specific details. In other instances, well-known structures are not shown in detail in order to avoid unnecessary obscuring of the present invention.

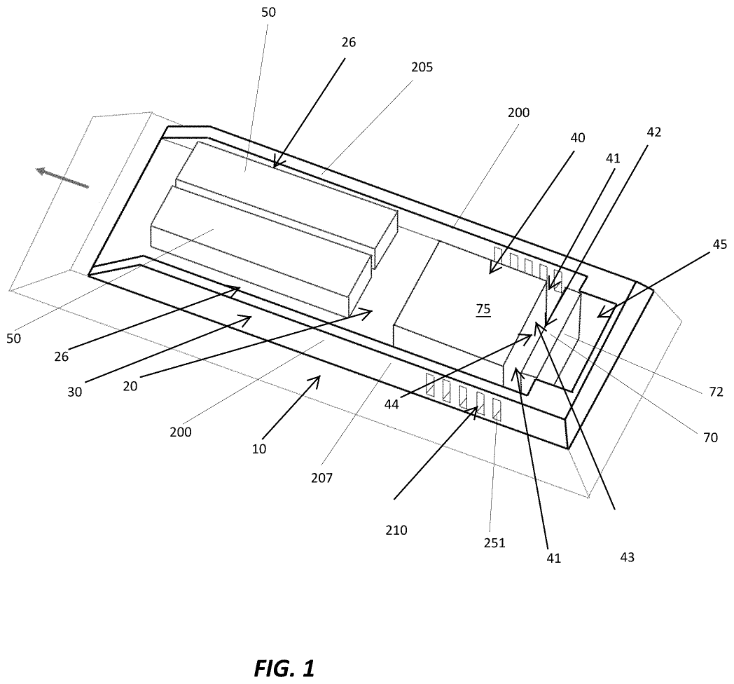

Thus, all the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In accordance with the principals of the present invention, systems and methods for thermally managing a source of electric current for a vehicle are provided. In an exemplary embodiment depicted in FIGS. 1-3, a vehicle 10 may include a cavity 20 on a top side 30 thereof to receive an electrical current generator 40 and a fuel source 50 for the generator.

Generator 40 may be a fuel cell stack or a battery, such as a lithium ion battery, for powering vehicle 10. For example, generator 40 may be coupled directly to electric motors connected to one or more driveshafts to cause a movement of the vehicle or generator 40 may be coupled to a storage device (e.g., a battery) on another portion (e.g., outside cavity 20) of vehicle 10 which may itself be connected to one or more driveshafts to cause the movement of the vehicle.

Fuel source 50 may include one or more hydrogen canisters connected to electrical generator 40 (e.g., a fuel cell stack) to provide hydrogen to the generator to allow a production of electrical energy by the generator.

A cover 100 may be connected to top side 30 and may include a central solid portion 105 bounded by side open portions 110 and a rear open portion 120 bounded by lateral edges of cover 100 contacting top side 30. The open portions (e.g., side open portions 110 and rear open portion 120) may allow airflow therethrough while the solid portion inhibits any such airflow. The airflow is desirable to allow cooling of the generator via heat rejection from a coolant inside a radiator to the ambient as described below.

One or more fans 42 (FIGS. 1,4) may be located in a front or at a rear of a radiator 70 to pull air into a fan entry cavity 43 in the front of radiator 70. Such fans could be located at a rear of generator 40 and configured to pull air into cavity 20 and into fan entry cavity 43 via inlets 41 on opposite sides of generator 40 and via a gap between a top of generator 40 and cover 100. The fan(s) may direct the air from fan entry cavity 43 rearward through radiator 70 to a fan exit cavity 45 after a coolant fluid in fluid communication with the generator has been cooled by radiator 70 thereby maintaining a desired temperature of the generator. The heated air may exit cavity 20 from fan exit cavity 45.

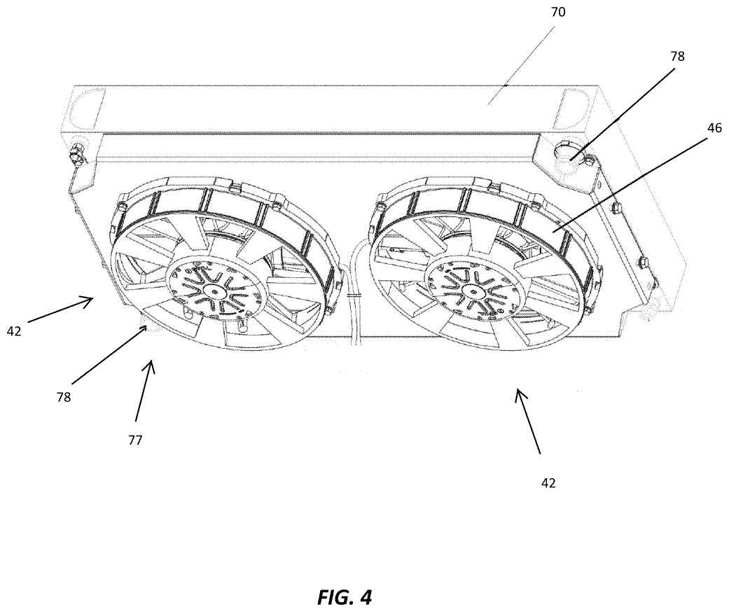

For example, a fan 46 of fans 42 may be attached to radiator 70 to form a fan-radiator assembly 77 as depicted in FIG. 4. Fan-radiator assembly 77, or radiator 70, may be located at a rear position 72 of (e.g., and spaced from) generator 40, such that assembly 77 or radiator 70 may be longitudinally spaced from generator 40 relative to a longitudinal dimension of vehicle 10, as depicted for example in FIG. 1. Radiator 70 may include one or more conduits (not shown) in fluid communication with an electricity generating portion 75 (e.g., a fuel cell stack) of generator 40 located toward fuel source 50 relative to fan location 42 and rear end 72. A coolant fluid may flow from electricity generating portion 75 to radiator 70 via the coolant conduits (not shown) such that the coolant may be cooled by the flow of air from the fan through radiator 70.

As depicted in FIG. 4, assembly 77 may include coolant connections 78 to allow the conduits to connect to radiator 70 to allow a flow of the coolant through radiator 70 to control a temperature (e.g., cool) of the coolant flowing from the generator through the conduits to radiator 70.

In another example, radiator assembly 77 or radiator 70 may be located at another location, instead of top side 30. For example, assembly 77 may be located in a location or a compartment of a vehicle (e.g., vehicle 10) where air flow may be directed through radiator 70 via conduits or other passages for directing air flow. Such assembly could be located away from a front of the vehicle (e.g., vehicle 10) such that air may be directed thereto utilizing conduits, openings, and/or louvers (e.g., louvers 250) to provide a lower kinetic pressure and higher static pressure to the assembly, relative to ambient conditions, when the vehicle is in motion.

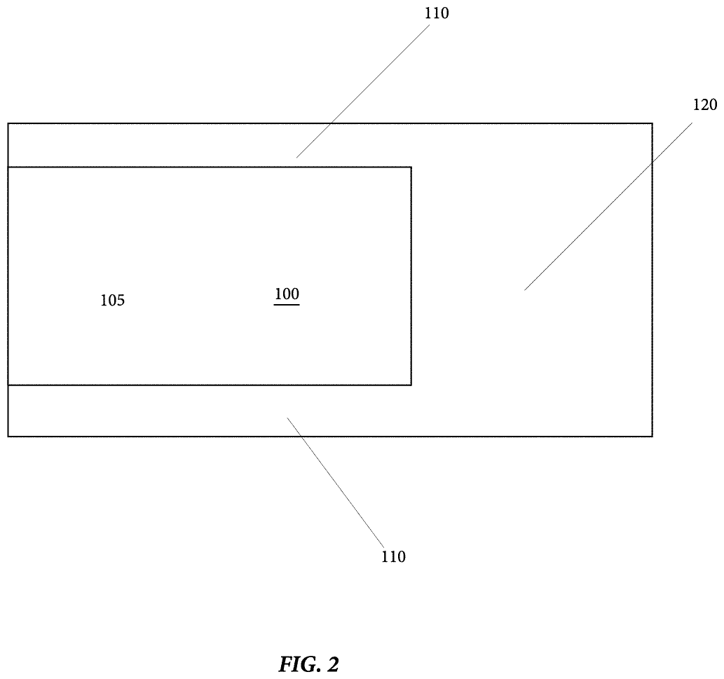

In an example, as vehicle 10 moves forward, air may enter through side portions 110 of cover 100 (FIG. 2) into side cavities 26 located on opposite sides of fuel source 50 and also air may flow into cavity 20 through rear portion 120 as depicted in FIGS. 1-2. A motion of the vehicle may facilitate such air flow, along with the fans (e.g., fans, 42) pulling air into cavity 20, into fan entry cavity 43 and toward fan exit cavity 45 to cool coolant fluid flowing through radiator 70 via air flow through radiator 70. The air may flow longitudinally relative to a longitudinal dimension of vehicle 10 from an entry point anywhere alongside portions 110 or on rear portion 120 to inlets 41 on opposite sides of generator 40, for example.

As described above, air may flow into fan entry cavity 43 via inlets 41. Generator 40 is depicted with inlets 41 on longitudinal sides (relative to a longitudinal dimension of vehicle 10) thereof and a top inlet 44 to cavity 43 such that air could enter cavity 43 via such side inlets 41 or top inlet 44. Further, air could flow from an opening (not shown) at a front of cover 100, through an opening (not shown) at front of vehicle 10, or from side portions 110 between tanks of fuel source 50 (e.g., hydrogen storage tanks) to top inlet 44. In another example not depicted, a generator (e.g., generator 40) could have a top covering top inlet 44 such that air may only enter cavity 43 via inlets 41.

Further, vehicle 10 may include air entry side portions 210 on opposite lateral longitudinal sides 200, or walls, of top side 30 relative to the longitudinal dimension of vehicle 10. Lateral sides 200 may have inner surfaces 205 which bound cavity 20 such that a venting portion 210 may allow a flow of air from an ambient environment past an outer surface 207 of one of lateral sides 200 into cavity 20. Such air flow from the ambient environment through venting portion 210 may allow a control of a temperature of generator 40 as described above relative to air flow through cover 100.

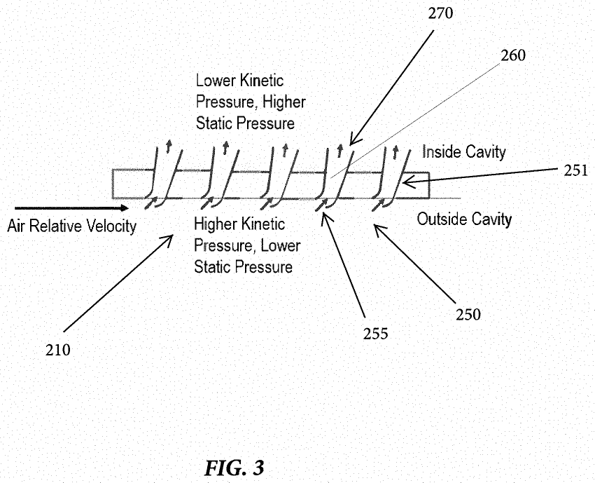

In an example, venting portion 210 may include louvers 250 as depicted in FIG. 3 and air may flow through the louvers into cavity 20 when vehicle 10 is in motion. For example, a first louver 251 of louvers 250 may include an entry 255, a passage portion 260 and an outlet 270 such that entry 255 is narrower than outlet 270 and air may decrease in velocity as it flows through first louver 251. Further, after flowing through the louver, a lower kinetic pressure and higher static pressure may result. Sizes and dimensions for such louvers (e.g., louvers 250) acting as air collectors and kinetic energy diffusers can be optimized based on application parameters such as vehicle moving speed, fan and radiator size and performance, and layout, etc. Further, there may be a plenum (not shown) to connect the louvers and further direct air into fan entry cavity 43.

As depicted in FIG. 3, an axis of entry 255 may be aligned offset to a longitudinal dimension of vehicle 10 (e.g., at 30-45 degrees) such that motion of the vehicle may facilitate entry of air through entry 255 into cavity 20 in the most efficient way. For example, the axis of entry 255 may be aligned at about 30 degrees relative to the longitudinal dimension of the vehicle and an axis of outlet 270 may be closer to perpendicular (e.g., 60-75 degrees) relative to the longitudinal dimension of the vehicle for the best kinetic energy conversion and to guide the air flow into the fan inlet in the most efficient way. Although first louver 251 is described above, other of louvers 250 may be similar or identical thereto.

As indicated above, a motion of vehicle 10 may result in air flow through cover 100 and/or louvers 250 toward the fan of generator 40. Although louvers 250 are depicted on lateral sides 200 of top side 30, such louvers could also be located on other portions of vehicle 10 to provide fluid communication with cavity 20, such as cover 100. In the case of such louvers being utilized, the kinetic energy due to the movement of the vehicle may convert part of the kinetic energy of a high-speed air stream passing the moving vehicle into a static pressure in front (e.g. in fan entry cavity 41 or a specially designed plenum) of the fan(s) (e.g., fans 42). Thus, the fan inlet air static pressure and density may therefore increase in a situation comparing a non-moving vehicle to a moving vehicle and further in the case where louvers (e.g., louvers 250) are present versus the situation where no louvers (e.g., louvers 250) or other air kinetic pressure conversion openings on lateral sides 207 and/or top cover 100 of vehicle 10 would be present, for example. A fan would thus be required to direct less volumetric air flow through a radiator (e.g., radiator 70) in the situation of a moving vehicle having louvers (e.g., louvers 250) directing air through a side or the top of a vehicle (thereby increasing air pressure and density at an incoming side of such a fan) than in the absence of such louvers since the louvers provide an increased static pressure in front (e.g., in fan entry cavity 41 or specially designed plenum) of the fan relative to a lack of such louvers. Sizes and dimensions for such louvers (e.g., louvers 250) utilized for air collector and kinetic energy diffusion may be optimized based on application parameters such as vehicle moving speed, fan and radiator size and performance, and a layout of the system components described above, for example.

Further, additional open space in a front and rear of fan-radiator assembly 77 may enable higher air flow rate through the fan-radiator assembly and may increase a heat rejection from the radiator to the environment (i.e., allowing better fuel cell power performance). As indicated above, coolant flows from generator 40 where the coolant is heated, enters the radiator (e.g., via coolant connections 78), and passes (or rejects) the heat to the air flowing through the radiator. Denser air (e.g., air with a higher pressure) may enter cavity 20 as described above and may provide more heat transfer from the radiator per unit time when flowing through the radiator relative to less dense or lower pressure air which promotes efficiency of the radiator and generator.

Further for a given heat rejection demand by an electrical generator, (e.g., generator 40) a fan size can be reduced when the louvers (e.g., louvers 250), are included as described above compared to a lack of such louvers, because a needed volumetric flow is reduced due to increased inlet air density to maintain a same mass flow rate. The needed static pressure across the fan(s) (e.g., at fan location 42) may be reduced due to increased fan inlet static pressure. Thus, a size and the power of the fans may therefore be reduced in the situation where venting portion 210 (e.g., including louvers 250) is utilized.

While several aspects of the present invention have been described and depicted herein, alternative aspects may be effected by those skilled in the art to accomplish the same objectives. Accordingly, it is intended to cover all such alternative aspects as fall within the true spirit and scope of the invention.

We claim:

1. An electrical generation system for a vehicle, comprising:
a vehicle having a generator for producing electric current:
the vehicle having a cavity having a fan and a radiator;
the radiator in fluid communication with the generator to allow a temperature of the generator to be controlled; and
an air inlet passage through a wall of the vehicle configured to direct air from outside the vehicle toward an inlet side of the radiator to provide an increased static pressure of the air to the inlet side of the radiator compared to an ambient pressure of the air when the vehicle is in motion.

2. The system of claim 1 wherein the passage comprises a first end on an outside surface of the wall and a second end in the interior cavity, wherein the first end is smaller than the second end such that air flowing from the first end to the second end increases in static pressure and decreases in kinetic pressure.

3. The system of claim 1 wherein the fan and the radiator are connected to each other and the fan is configured to direct air through the radiator.

4. The system of claim 1 wherein the passage comprises a first louver of a plurality of louvers extending through the wall of the vehicle.

5. The system of claim 1 wherein the vehicle comprises a roof having a roof cavity receiving the generator, the radiator and the fan.

6. The system of claim 5 further comprising a fuel source received in the roof cavity and in fluid communication with the generator.

7. The system of claim 1 wherein the wall comprises a side longitudinal wall of a top of the vehicle.

8. The system of claim 5 further comprising a cover attached to the top of the vehicle covering the fuel source.

9. The system of claim 8 further comprising side passages bounded by the wall and the fuel source on opposite longitudinal sides of the fuel source to direct air from a front end of the vehicle into the interior cavity toward the radiator located behind the fuel source toward a rear end of the vehicle.

10. The system of claim 1 wherein the wall comprises a cover attached to the top of the vehicle.

11. The system of claim 1 wherein the wall comprises a side of the vehicle below a roof

12. A method for controlling a temperature of an electrical generator, comprising:
connecting an electrical generator in a vehicle to a radiator in the vehicle via a conduit to provide fluid communication between the electrical generator and the radiator to allow the radiator to cool the electrical generator via a flow of fluid between the electrical generator and the radiator;
flowing air from an outside of the vehicle to an inlet side of the radiator through an air inlet passage of the vehicle to provide an increased static pressure of the air to the inlet side of the radiator compared to an ambient pressure of the air when the vehicle is in motion.

13. The method of claim 12 wherein the passage comprises a first end on an outside surface of the wall and a second end inside the vehicle, wherein the first end is smaller than the second end such that air flowing from the first end to the second end increases in static pressure and decreases in kinetic pressure.

14. The method of claim 12 wherein a fan and the radiator are connected to each other and the fan is configured to direct air through the radiator.

15. The method of claim 12 wherein the passage comprises a first louver of a plurality of louvers extending through the wall of the vehicle.

16. The method of claim 12 wherein the vehicle comprises a roof having a roof cavity receiving the generator, the radiator and the fan.

17. The method of claim 16 further comprising a fuel source received in the roof cavity and in fluid communication with the generator.

18. The method of claim 17 further comprising directing air through side passages bounded by a wall of the vehicle and the fuel source on opposite longitudinal sides of the fuel source to direct air from a front end of the vehicle toward the radiator located behind the fuel source toward a rear end of the vehicle.

19. A system for controlling a temperature of an electrical generator, comprising:
a radiator in a vehicle coupled to an electrical generator in the vehicle via a conduit to provide fluid communication between the electrical generator and the radiator to allow the radiator to cool the electrical generator via a flow of fluid between the electrical generator and the radiator; and
an air inlet passage of the vehicle configured to direct air from an outside of the vehicle to an inlet side of the radiator to provide an increased static pressure of the air to the inlet side of the radiator compared to an ambient pressure of the air when the vehicle is in motion.

20. The system of claim 19 further comprising a fan located in the vehicle in front of the radiator to direct air to the inlet side of the radiator.
